(19) United States
(12) Patent Application Publication
(10) Pub. No.: US 2012/0042590 A1
(43) Pub. Date: Feb. 23, 2012

(54) Door-Stop Device

(76) Inventor: Victor Ben-David Yosef, Maalot (IL)

(21) Appl. No.: 13/266,426

(22) PCT Filed: Apr. 28, 2010
(86) PCT No.: PCT/IL10/00343

§ 371 Date: Oct. 26, 2011

Related U.S. Application Data
(60) Provisional application No. 61/173,229, filed on Apr. 28, 2009.

(51) Int. Cl. E06B 1/04; E05B 1/00; E06B 7/28; E05F 5/04

(52) U.S. Cl. 52/204.1; 16/82; 16/86 R; 16/412; 49/70

(57) ABSTRACT

A door-stop device for a door hingedly set in a doorframe and equipped with a door handle assembly rotatable between a first, untensioned position and a second, tensioned position, including: (a) an obstruction assembly; (b) an extension arm having a first and second ends, the first end connected to the obstruction assembly, and (c) a securing mechanism, connected to the second end of the extension arm, and including a collar adapted, in a relaxed position, to partially encompass a rotatable portion of the door handle assembly, the collar associated with first and second tabs having first and second openings, the openings adapted to receive a closure member therethrough, wherein, when the securing mechanism is secured to the door handle assembly, and the door is set within the doorframe, the obstruction assembly is adapted to rotate in direct relation to a rotation of the door handle assembly between the first and second positions; the extension arm and the obstruction assembly are adapted whereby, when the door is closed, and the door handle assembly is disposed in the untensioned position, the obstruction assembly is urged against the doorjamb; the extension arm and the obstruction assembly are adapted whereby, when the door handle assembly is disposed in the tensioned position, the obstruction assembly is clear of the doorframe; and the extension arm and the obstruction assembly are adapted whereby, when the door is open with respect to the doorframe, and the door handle assembly is disposed in the untensioned position, a portion of the obstruction assembly is interposed between the door and the doorframe to inhibit the door from closing against the doorframe.

This application is a national phase application of PCT/IL2010/000343 filed Apr. 28, 2010, drawing priority from U.S. Provisional Patent Application Ser. No. 61/173,229, filed Apr. 28, 2009.

### FIELD AND BACKGROUND OF THE INVENTION

The present invention relates to a door-stop device, and more particularly, to a door-stop device adapted to serve as a safety device by interposition between a rotating door and a doorjamb.

Approaches to door-stop devices are provided in U.S. Pat. No. 5,652,998 to McKenzie, and in my PCT Patent Publication No. WO 2008081429, both of which are incorporated by reference for all purposes as if fully set forth herein. These devices have an arm having a chock at one end, for obstructing the closing of the door, and a fastening mechanism, for securing the device to a shaft of a rotating door mechanism.

With the door in a closed position, the chock is disposed in a loaded position in which the chock exerts pressure against the doorjamb. When the door is opened, the chock is no longer restrained by the doorjamb, and the chock assumes a blocking position between the doorjamb and the door.

Such door-stop devices must satisfy additional design criteria. The prior art has recognized that the door-stop device may be designed such that when the door handle is rotated, the chock rotates therewith, changing position from a blocking position to an upright position, whereby the door may be closed unimpaired. When the door handle is subsequently released, the chock returns to the normal, loaded position in which the chock exerts pressure on the doorjamb.

The spring force of the device arm may be advantageously less than the spring force of the rotating shaft of the door mechanism in the direction of the shaft's relaxed, untensioned, or natural position, otherwise, the force exerted by the chock against the door frame will not allow the door handle to resume this untensioned position.

In reducing the invention to practice, I have found that there exists a plethora of engineering design requirements and constraints for such door-stop devices, some of which do not appear to have been contemplated, or do not appear to have been solved, based on the teachings of the prior art. Thus, the advances made by prior art devices notwithstanding, the present inventor has recognized a need for improved door-stop devices.

### SUMMARY OF THE INVENTION

According to the teachings of the present invention there is provided a door-stop device or mechanism for a door hingedly set in a doorframe and equipped with a door handle assembly rotatable between a first, untensioned position and a second, tensioned position, the device including: (a) an obstruction assembly; (b) an extension arm having a first end and a second end, the first end connected to the obstruction assembly, and (c) a securing mechanism, connected to the second end of the extension arm, the securing mechanism including a collar adapted, in a relaxed position, to partially encompass a rotatable portion of the door handle assembly, the collar associated with a first tab having a first opening and a second tab having a second opening, the openings adapted to receive a closure member therethrough, wherein, when the securing mechanism is secured to the door handle assembly, and the door is set within the doorframe, (i) the obstruction assembly is adapted to rotate in direct relation to a rotation of the door handle assembly between the first position and the second position; (ii) the extension arm and the obstruction assembly are adapted whereby, when the door is closed with respect to the doorframe, and the door handle assembly is disposed in the untensioned position, the obstruction assembly is urged against a doorjamb of the doorframe; (iii) the extension arm and the obstruction assembly are adapted whereby, when the door handle assembly is disposed in the tensioned position, the obstruction assembly is clear of the doorframe; and (iv) the extension arm and the obstruction assembly are adapted whereby, when the door is open with respect to the doorframe, and the door handle assembly is disposed in the untensioned position, a portion of the obstruction assembly is interposed between the door and the doorframe to spacedly inhibit the door from closing against the doorframe.

The door-stop device may include any feature described, either individually or in combination with any feature, in any configuration.

According to further features in the described preferred embodiments, the first tab is attached to a first end of the collar, and the second tab is attached to a second end of the collar, and the second end of the extension arm may be attached to the collar.

According to still further features in the described preferred embodiments, the first tab is attached to a first end of the collar, and the second tab is attached to a second end of the collar, and wherein the second end of the extension arm, a base of the first tab, and the first end of the collar, form a juncture.

According to still further features in the described preferred embodiments, the second end of the extension arm is attached to the securing mechanism in a position proximal to the collar, with respect to the first opening.

According to still further features in the described preferred embodiments, the door-stop device further includes the closure member, and the closure member may include a bolt or a screw.

According to still further features in the described preferred embodiments, the closure member is adapted to bridge between the tabs, and/or to draw together respective inner faces of the tabs.

According to still further features in the described preferred embodiments, the tabs are adapted whereby, when the collar is in an open or relaxed condition, an angle between the inner faces is at least 7°, at least 10°, at least 15°, between 10° and 45°, between 15° and 40°, or between 20° and 35°.

According to still further features in the described preferred embodiments, when the securing mechanism is secured to the door handle assembly, and the door is set within the doorframe, the extension arm has a first surface adapted to face the doorjamb, and wherein the first surface and the collar are attached whereby an inner facing of the collar and the first surface of the extension arm are disposed in substantially a same direction.

According to still further features in the described preferred embodiments, the grooves are disposed in the inner facing of the collar.

According to still further features in the described preferred embodiments, each of the grooves is adapted to receive an insert, the insert protruding past the inner facing of the collar, and adapted to engage, when the securing mechanism is secured to the door handle assembly, an external surface of a rotating shaft of the door handle assembly.

According to still further features in the described preferred embodiments, the first surface is a generally concave surface.

According to still further features in the described preferred embodiments, the extension arm has a second surface adapted to face away from the doorjamb, and the obstruction assembly is associated with, or substantially disposed between, the first surface and the second surface.

According to still further features in the described preferred embodiments, the openings include at least one recessed opening.

According to still further features in the described preferred embodiments, the openings are elongated openings dimensioned to provide mobility to the closure member as the closure member moves from one position to another position, and wherein the elongated openings may be substantially rectangular, oval, or rectangular with rounded ends.

According to still further features in the described preferred embodiments, the arm includes, largely includes, substantially includes, or consists essentially of a resilient, flexible memory shape material such as a polyoxymethylene thermoplastic polymer.

According to still further features in the described preferred embodiments, the collar and the tabs include, largely include, substantially include, or consist essentially of a resilient, flexible substantially perfectly elastic material such as a polyoxymethylene thermoplastic polymer.

According to still further features in the described preferred embodiments, the obstruction assembly includes at least one obstruction cushion, laterally protruding from both sides of the extension arm, and, adapted to at least partially absorb an impact between the door and the doorjamb.

According to still further features in the described preferred embodiments, the at least one obstruction cushion is at least a pair of obstruction cushions, each of the pair protruding from one side of the sides of the arm.

According to still further features in the described preferred embodiments, the extension arm includes a support frame disposed underneath the at least one obstruction cushion or between the pair of obstruction cushions, whereby the impact may be at least partially distributed over all of the support frame.

According to still further features in the described preferred embodiments, the pair of obstruction cushions mechanically intercommunicates via the support frame, whereby the impact is transferred and distributed between the cushions.

According to still further features in the described preferred embodiments, the cushion or cushions are made of a resilient, flexible material such as a thermoplastic rubber.

According to still further features in the described preferred embodiments, the door-stop device further includes the doorjamb.

According to still further features in the described preferred embodiments, the door-stop device further includes the door handle assembly.

According to still further features in the described preferred embodiments, the door-stop device further includes the door.

According to still further features in the described preferred embodiments, a tab of the tabs has a recess adapted to receive a threaded nut or element that is complementary with a surface of the closure member.

According to still further features in the described preferred embodiments, the recess has a contour or a protruding element adapted to seat the threaded nut or element, whereby in an initial, untensioned, open position of the collar, with the closure member inserted through the openings, the threaded nut or element is disposed within 10°, within 8°, or within 5° of perpendicular, with respect to a longitudinal axis of the closure member.

According to still further features in the described preferred embodiments, when a distance between a rotating shaft of the door handle assembly and a leading edge of the door is within a range of about 25 mm to about 65 mm, the door-stop device is adapted to universally function within an entire breadth of the range.

According to still further features in the described preferred embodiments, the distance between a center of the collar and a distal edge of the door-stop device (typically the obstruction element) is at least 11 cm, at least 11.5 cm, at least 12 cm, or at least 12.5 cm.

According to still further features in the described preferred embodiments, the distance between the center of the collar and the distal edge of the door-stop device is less than 20 cm, less than 18 cm, less than 16 cm, or less than 15 cm.

According to still further features in the described preferred embodiments, the distance between a center of the collar and a distal edge of the door-stop device is at least 11 cm, at least 11.5 cm, at least 12 cm, or at least 12.5 cm, whereby, when a distance between a rotating shaft of the door handle assembly and a leading edge of the door is within a range of about 20 mm or 25 mm to about 65 mm, the door-stop device is adapted to universally function within an entire breadth of the range.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

In the drawings:

FIG. 1 is a perspective view of the device according to one aspect of the present invention;

FIG. 1a is another perspective view of the device of FIG. 1;

FIG. 2a is a perspective view of one aspect of the device of the present invention, mounted on a door handle, the door opening mechanism being rotated to a first, open position;

FIG. 2b is a perspective view of the device of FIG. 2a, wherein the door opening mechanism is disposed in a second, closed position, and the door-stop device obstructs the closing of the door;

FIG. 2c is a perspective view of the device of FIG. 2a, wherein the door opening mechanism is disposed in a second, closed position, the door is closed, and the door-stop device exerts a pressure on the adjacent doorjamb;

FIG. 3a is a first side perspective view of the device of the present invention. FIG. 3b is a top perspective view of the device provided in FIG. 3a. FIGS. 3c-3g provide cross-sectional views of the device provided in FIG. 3a;

FIGS. 4a-4d are schematic side perspectives of the inventive device, in which the securing assembly is secured around rotating shafts of a rotatable mechanism for extending and retracting a bolt adapted to be received by the doorjamb;

FIG. 5 is a second side perspective view of the device provided in FIG. 3a; and

FIGS. 6a and 6b schematically show how, as the door handle is turned, the receding distance of the device from the leading edge of the door strongly depends on the initial angle of the device against the doorjamb, and upon the angle of rotation of the shaft of the door handle.

### DESCRIPTION OF THE PREFERRED EMBODIMENTS

The principles and operation of the door-stop device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In reducing the invention to practice, I have found that there exist numerous and varied engineering design requirements and constraints for such door-stop devices, some of which do not appear to have been contemplated, and/or solved, by the teachings of the prior art.

It would also be highly advantageous to have a door-stop device that is substantially universal for conventional doors, doorframes, and door handle assemblies, such that the device functions substantially irrespectively of the distance between the rotating shaft of the door handle assembly and the leading edge of the door, irrespectively of the angle of rotation of conventional door-handle shafts, and irrespectively of the spring forces exerted by conventional, household, rotating door-opening mechanisms. It would also be of particular advantage to have a door-stop device that is compact, robust, relatively unobtrusive to the user, and economical.

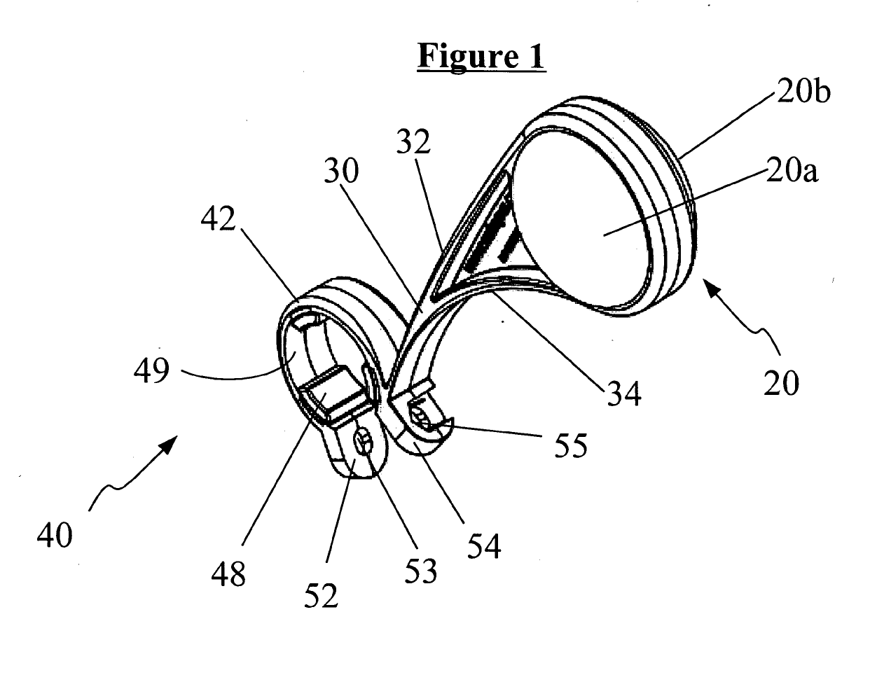

In accordance with the present invention, a door-stop device for a door with a rotatable door-opening mechanism and a doorjamb is provided. Referring now to FIG. 1, the door-stop device of the present invention includes an obstruction element or assembly 20 which is capable of withstanding the closing force asserted on an object positioned between the closing door and the doorjamb. The obstruction element is constructed of a material rigid enough to maintain its shape upon impact, yet flexible enough to prevent damage to the door upon closing. The obstruction element of the invention is constructed of a width such that when it is placed between the door and the doorjamb, the gap between the door and the doorjamb is wider than the width of a human finger or hand.

Obstruction element or assembly 20 may consist of one or more cushions such as cushion 20a and cushion 20b. Obstruction element or assembly 20 may be connected at a first end to an extension arm 30, which is, in turn, connected to a securing element or assembly 40, which may include a collar or clasp 42 and a closure member or screw 44. At the ends of collar 42 may be disposed tabs or tabs 52, 54, having respective openings 53, 55, adapted to receive the screw or bolt of the closure mechanism. Typically, openings 53, 55 may be recessed openings.

It may be advantageous to construct the inventive device such that the bolt or screw is inserted through opening 53, such that the head of the screw or bolt is obstructed from passing through by tab 52. The distal end of the screw or bolt may be passed through opening 55.

The obstruction element, arm, and clasp may be molded together in such a manner as to create a single integral, semi-rigid structure.

The extension arm may advantageously have a generally flat or slightly curved upper surface 32 (disposed, in working configuration, distally to the doorjamb), and a curved or concave lower surface 34 (disposed, in working configuration, laterally to the doorjamb). Obstruction element may be held between surface 32 and surface 34.

The device may advantageously be constructed whereby an inner facing 49 of the collar and the concave lower surface of the extension arm are disposed in the same or substantially the same direction (i.e., the direction of the doorjamb, when the device is in working configuration).

Collar or clasp 42 may be placed around the rotating shaft section of the door opening mechanism, such as a door knob or handle (or another rotating element of the rotating door-opening mechanism), and is held in fixed relation to this rotating section by a closure member or screw. By securing the clasp to the rotating shaft of the door-opening mechanism, the obstruction element of the invention will move in a direct relation to the rotation of the door-opening mechanism.

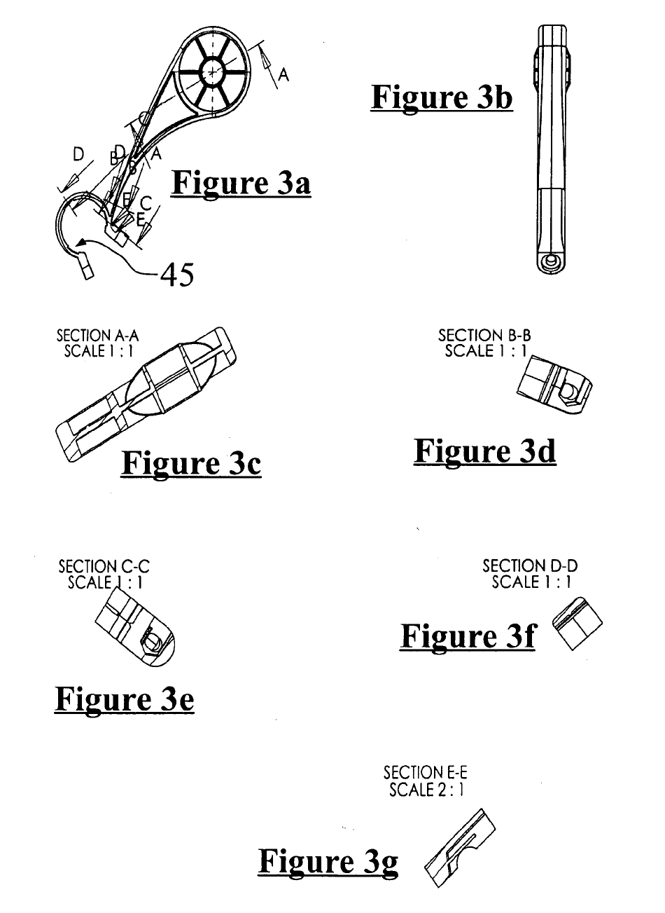

FIG. 3a is a first side perspective view of one embodiment of the device of the present invention. FIG. 3b is a top perspective view of the device provided in FIG. 3a. FIGS. 3c-3g provide cross-sectional views of the device provided in FIG. 3a.

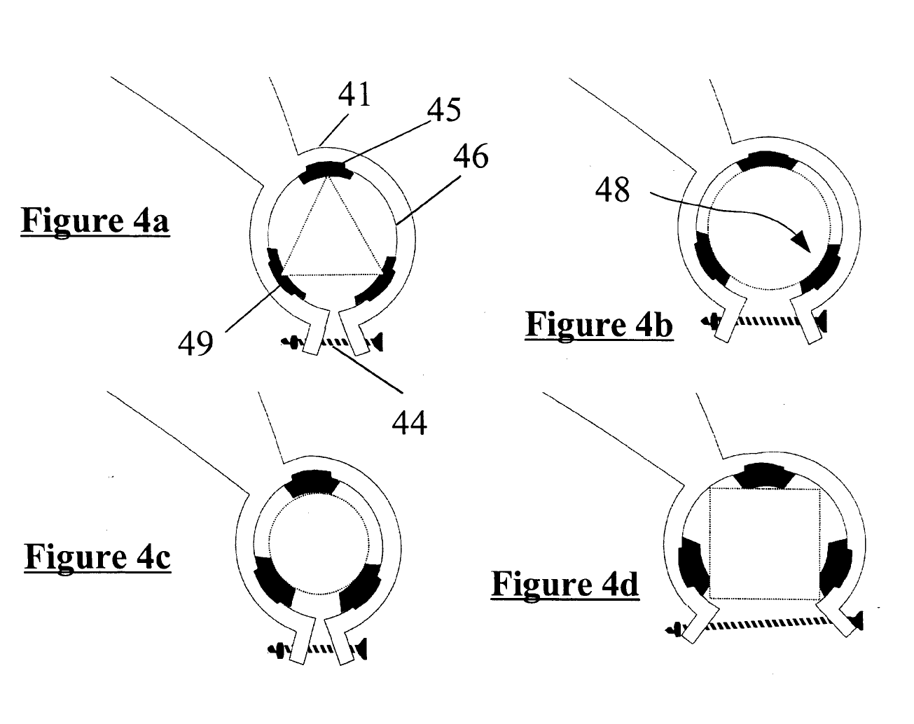

FIGS. 4a-4d are schematic side perspectives of the inventive device, in which the securing assembly is secured around rotating shafts of a rotatable mechanism for extending and retracting a bolt adapted to be received by the doorjamb. The rotating shafts may have cross-sections (substantially parallel to the face of the door)) widely varying in contour and/or in area. The contours shown are triangular (FIG. 4a), circular (FIGS. 4b and 4c), and square (FIG. 4d).

Grooves such as groove 45 may be disposed in an inside facing 46 of the collar. The grooves may be adapted to receive inserts such as insert 48. The inserts may have a first surface that is complementary or at least partially complementary to the groove, such that the insert snaps into, fits snugly into, or is otherwise secured to the collar.

The inserts may protrude above the inner facing of the collar, so as to engage the external surface of the rotating shaft. Depending on the geometry and size of the rotating shaft, at least one such insert, and typically, at least two or three such inserts, may be required to engage the external surface thereof. The securing assembly is adapted such that when the closure member (such as a screw or bolt) is tightened or screwed, the collar is partially closed, whereby the inserts firmly and fixedly engage the external surface of the rotating shaft.

The cross-sectional area of the circular rotating shaft in FIG. 4b is larger than the cross-sectional area of the circular rotating shaft in FIG. 4c by about 50%. Shafts having differences of more than 100% in the cross-sectional area may be used in conjunction with the device of the present invention, using the same collar, whereby the securing mechanism fixedly engages the external surface of the rotating shaft. Consequently, the obstruction element will move in a direct relation to the rotation of the door-opening mechanism, substantially irrespective of the shaft circumference. Thus, the securing mechanism is substantially a universal mechanism that can receive virtually any profile of rotating shaft, along with a wide variety of shaft sizes.

It may be advantageous to provide a kit containing the door-stop device of the present invention, including the closure mechanism, along with inserts of two or more thicknesses, to accommodate a wide variety of rotating shaft sizes and profiles.

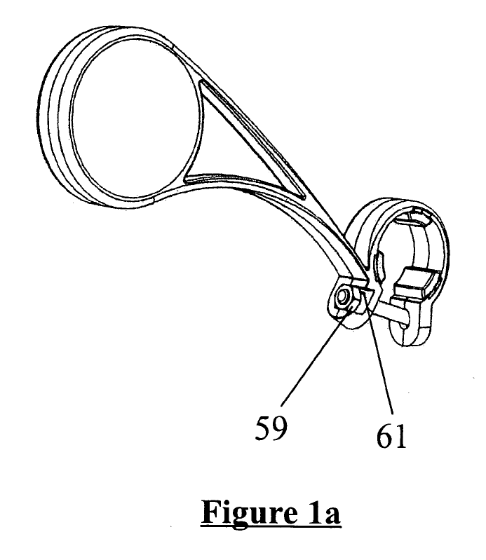

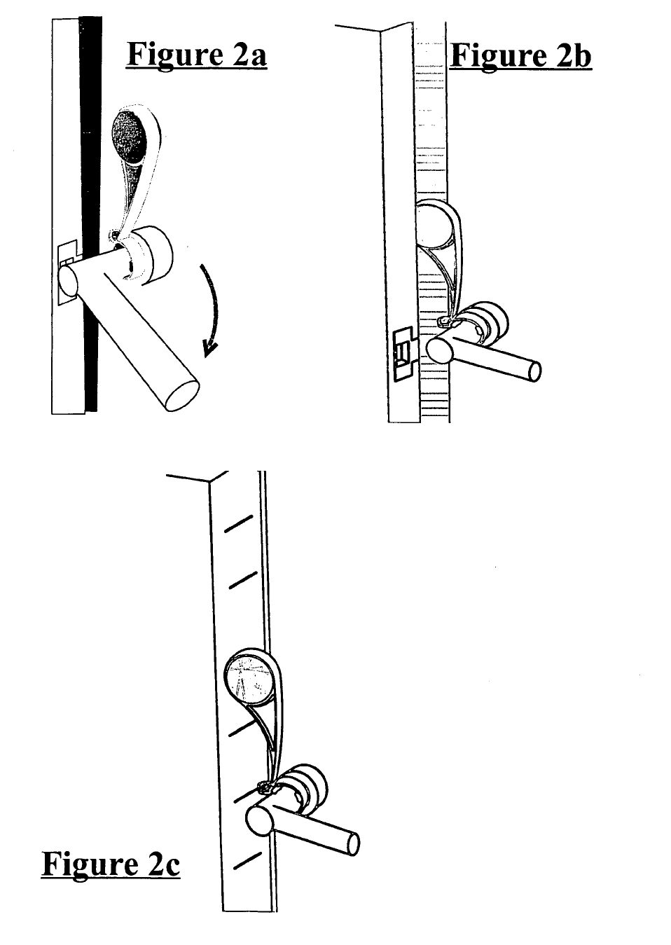

When the door-opening mechanism is rotated to a first, open position (FIG. 2a), the obstruction element of the invention will be located in a position away from the edge of the door and the doorjamb. Typically, this position may be above the rotating shaft of the door-opening mechanism.

When the door is open and the door-opening mechanism is in a second, closed position, the obstruction element of the invention is located in a second, somewhat more horizontal position, with respect to the first position (FIG. 2b). While in this closed position, the obstruction element extends past the edge of the door and may contact the doorjamb to prevent the door from completely shutting. Consequently, the obstruction element prevents the door from crushing or contacting an object located between the edge of the door and the doorjamb, such as a human finger or fingers.

To close the door completely, the rotating door mechanism may be held in an open position, at which time the obstruction element of the invention is located in the first, non-obstructing position. In this position, the door may be closed, since the obstruction element is located away from the edge of the door. Once the door is closed, the door-opening mechanism may be released to allow the door-opening mechanism to return to its resting position, enabling the door bolt to extend into the doorjamb. The arm and/or obstruction element are adapted such that, as the door-opening mechanism returns to its resting, closed position, the obstruction element attempts to return to its horizontal obstruction position. This may be accomplished by spring-loading the obstruction element and/or the extension arm.

However, the inside surface of the doorjamb typically prevents the obstruction element from returning to the second, more horizontal position. At this time, the arm may bend to allow the obstruction element to remain in a somewhat vertical position (typically leaning and exerting pressure against the door jam) while the fixed clasp returns with the rotating shaft to its closed position (FIG. 2c). Thus, to completely close the door, a person must hold the door-opening mechanism in an open position while simultaneously closing the door.

The obstruction element of the present invention may be constructed of a material flexible enough to prevent damage to the door and doorjamb and rigid enough to obstruct the door, upon closing. The material may advantageously be selected to deform upon impact from the door, and to substantially return to its shape after impact. Thermoplastic rubber has been found to be suitable for this purpose.

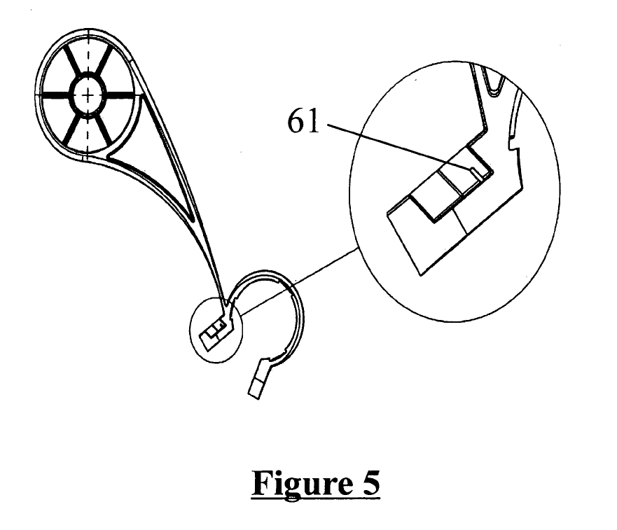

FIG. 5 is a second side perspective view of the device provided in FIG. 3a, and includes a detailed view of the tab of the collar that is proximal to the obstruction element.

As described hereinabove, at the ends of the collar may be disposed tabs 52, 54, having respective openings 53, 55, adapted to receive the screw or bolt of the closure mechanism. Typically, openings 53, 55 may be recessed openings. The openings may advantageously be elongated (rectangular, oval, rectangular with rounded ends, etc.) to provide mobility to the screw or bolt as the securing mechanism moves from one position to another.

It may be advantageous to construct the inventive device such that the bolt or screw is inserted through opening 53, such that the head of the screw or bolt is obstructed from passing through by tab 52. The distal end of the screw or bolt may be passed through opening 55.

I have found that when the collar is an open, relaxed position, the faces of the tab that face each other may advantageously have an angle of at least 10°, more typically, between 10° and 45°, and yet more typically, between 15° and 40°. In one embodiment of the present invention, it is presently preferred to have an angle between 20° and 35°. The angle between the faces helps the inside facing of the collar to assume a circular or close-to-circular profile, in the closed position, which may be critical in establishing a fixed relationship between the device and the rotating shaft. This is of particular importance in accommodating shafts of differing shapes and sizes.

After securing the device and the rotating shaft in this fixed relationship, the above-mentioned angle between the faces may be reduced by at least 5°, at least 10°, at least 15°, and typically, at least 20°, such that the openings in the faces assume a substantially linear arrangement. In absolute terms, the above-mentioned angle between the faces may be less than 10°, and typically, less than 5°. In fixed position, the screw or bolt may be tangential or substantially tangential (within 10°, more typically within 5°) to the inside facing of the collar or more specifically, to the inside facing of the center or top 41 (shown in FIG. 4a) of the collar.

One apparent disadvantage of the above-described angle between the faces of the tabs is that the openings are not linearly aligned in the initial, untensioned, open position of the collar. Consequently, inserting the screw or bolt through both tab openings and affixing a threaded element such as nut 59 to the threaded rod, as shown in FIG. 1 a, may become extremely challenging.

In a preferred embodiment, the face of the tab that faces the obstruction element may have a recess adapted to receive a threaded nut or element that is complementary with the threaded rod of the bolt or screw.

In another preferred embodiment, this recess may have a contour or have a protruding element 61 to seat the threaded nut such that in the initial, untensioned, open position of the collar, the nut and the inserted screw or bolt will be within 10°, more typically within 5° of perpendicular. Consequently, the collar can be secured with facility to the rotating shaft.

Preferably, the contour or protruding element have sufficient softness and/or flexibility such that, during the tightening of the closure mechanism, the nut maintains its largely perpendicular orientation to the threaded rod, while allowing the tabs of the collar to move towards each other, even as the angle between the tabs is reduced from a larger, initial angle (e.g., 30°) to a reduced angle (e.g., below 10°). The above-described elongated openings facilitate this transition.

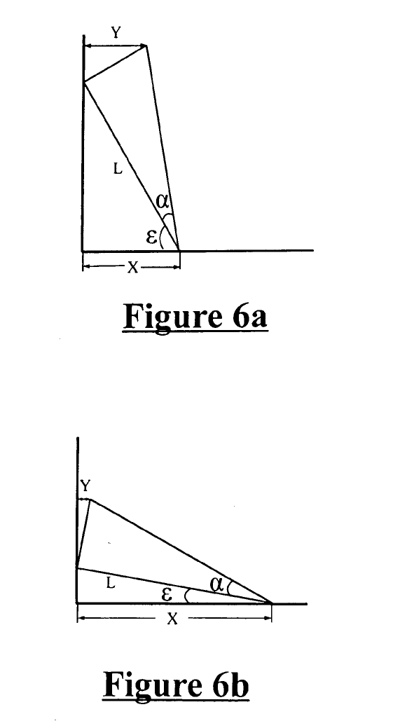

FIGS. 6a and 6b schematically show how, as the door handle is turned, the receding distance of the device from the leading edge of the door strongly depends on the initial angle of the device against the doorjamb, and upon the angle of rotation of the shaft of the door handle.

I have calculated the receding distance (Y) as a function of the length (L) of the door-stopping device initial angle (ε) of the device against the doorjamb, with respect to the horizontal plane, and the angle of rotation (α) of the shaft of the door handle.

The receding distance Y may be represented by the following equation:

Y=2·L·cos(90−α/2)·sin(ε+α/2)

For a particular device, L is constant, and the relative receding distance for various door-opening mechanisms is given by the following ratio:

Y₍ᵢ₎Y₍₂₎=[cos(90−α₍₁₎/2)·sin(ε₍₁₎+α₍₁₎/2)]/[cos(90−α₍₂₎/2)·sin(ε₍₂₎+α₍₂₎/2)]

By way of example, in a first case (shown schematically in FIG. 6a), α is 20° and ε is 60°; in a second case (shown schematically in FIG. 6b), α is 20° and ε is 10°. The relative receding distance is 2.76, which means that the receding or retracting distance along the horizontal plane in the first case is almost 3 times that of the receding distance in the second case.

We have discovered, however, that by choosing L within a fairly narrow range of lengths (typically at least about 11.5 cm and less than about less than 18 cm), the inventive door-stop device is adapted to universally function within the entire conventional range of distances between the rotating shaft of the door handle assembly and the leading edge of the door (about 20 mm to about 65 mm). Within this fairly narrow range of lengths, the inventive door-stop device is also adapted to universally function within the entire range of rotation angles of conventional door-handle shafts (typically about 10° to about 60°). Within this fairly narrow range of lengths, the inventive door-stop device is yet further adapted to universally function to exert a spring force that is smaller than the spring forces exerted by virtually all conventional, household, rotating door-opening mechanisms. Finally, within this fairly narrow range of lengths, the inventive door-stop device is compact, robust, relatively unobtrusive to the user, and economical.

As used herein in the specification and in the claims section that follows, the term “clear of”, with respect to an obstruction assembly and a doorjamb or doorframe, refers to an obstruction assembly that, when disposed, in working configuration, on a door set within its doorframe, is situated completely within a projection of a leading edge of the door, such that the closing of the door is unobstructed.

As used herein in the specification and in the claims section that follows, the term “percent”, or “%”, refers to percent by weight, unless specifically indicated otherwise.

Similarly, the term “ratio”, as used herein in the specification and in the claims section that follows, refers to a weight ratio, unless specifically indicated otherwise.

As used herein in the specification and in the claims section that follows, the term “largely includes”, with respect to a component within a formulation, refers to a weight content of at least at least 30%, at least 40%, at least 50%, or at least 60%.

As used herein in the specification and in the claims section that follows, the term “predominantly includes”, with respect to a component within a formulation, refers to a weight content of at least at least 50%, at least 65%, at least 75%, or at least 85%.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 10 should be considered to have specifically disclosed subranges such as from 1 to 2, from 1 to 5, from 1 to 8, from 3 to 4, from 3 to 8, from 3 to 10, etc., as well as individual numbers within that range, for example, 1, 2, 3, 4, 5, 6, 7, 8, 9, and 10. This applies regardless of the breadth of the range.

Similarly, the terms “at least”, “exceeds”, and the like, followed by a number (including a percent or fraction), should be considered to have specifically disclosed all the possible subranges above that number, as well as individual numerical values above that number. For example, the term “at least 75” should be considered to have specifically disclosed subranges such as 80 and above, 90 and above, etc, as well as individual numbers such as 85 and 95.

Similarly, the terms “less than”, “below”, and the like, followed by a number (including a percent, fraction, or ratio such as a weight ratio), should be considered to have specifically disclosed all the possible subranges below that number, as well as individual numerical values below that number. For example, the term “below 75%” should be considered to have specifically disclosed subranges such as 70% and below, 60% and below, etc, as well as individual numbers such as 65% and 50%.

Whenever a numerical range is indicated herein, the range is meant to include any cited numeral (fractional or integral) within the indicated range. The phrase “ranging/ranges between” a first number and a second number and “within a range of” a first number to a second number, and the like, are used herein interchangeably and are meant to include the first and second indicated numbers and all the fractional and integral numerals therebetween.

It will be appreciated by those of ordinary skill in the art that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A door-stop device for a door hingedly set in a doorframe and equipped with a door handle assembly rotatable between a first, untensioned position and a second, tensioned position, the device comprising:
(a) an obstruction assembly;
(b) an extension arm having a first end and a second end, said first end connected to said obstruction assembly, and
(c) a securing mechanism, connected to said second end of said extension arm, said securing mechanism including a collar adapted, in a relaxed position, to partially encompass a rotatable portion of the door handle assembly, said collar associated with a first tab having a first opening and a second tab having a second opening, said openings adapted to receive a closure member therethrough,
wherein, when said securing mechanism is secured to the door handle assembly, and the door is set within the doorframe,
(i) said obstruction assembly is adapted to rotate in direct relation to a rotation of the door handle assembly between the first position and the second position;
(ii) said extension arm and said obstruction assembly are adapted whereby, when the door is closed with respect to the doorframe, and the door handle assembly is disposed in the untensioned position, said obstruction assembly is urged against a doorjamb of the doorframe;
(iii) said extension arm and said obstruction assembly are adapted whereby, when the door handle assembly is disposed in the tensioned position, said obstruction assembly is clear of said doorframe; and
(iv) said extension arm and said obstruction assembly are adapted whereby, when the door is open with respect to the doorframe, and the door handle assembly is disposed in the untensioned position, a portion of said obstruction assembly is interposed between the door and the doorframe to inhibit the door from closing against the doorframe.

2. The door-stop device of claim 1, wherein said first tab is attached to a first end of said collar, and said second tab is attached to a second end of said collar, and wherein said second end of said extension arm may be attached to said collar.

3. The door-stop device of claim 1, wherein said first tab is attached to a first end of said collar, and said second tab is attached to a second end of said collar, and wherein said second end of said extension arm, a base of said first tab, and said first end of said collar, form a juncture.

4. The door-stop device of any of claims 1-3, wherein said second end of said extension arm is attached to said securing mechanism in a position proximal to said collar, with respect to said first opening.

5. The door-stop device of any of claims 1-4, further comprising said closure member, and wherein said closure member may include a bolt or a screw.

6. The door-stop device of claim 5, wherein said closure member is adapted to bridge between said tabs, and/or to draw together respective inner faces of said tabs.

7. The door-stop device of claim 6, wherein said tabs are adapted whereby, when said collar is in an open or relaxed condition, an angle between said inner faces is at least 7°, at least 10°, at least 15°, between 10° and 45°, between 15° and 40°, or between 20° and 35°.

8. The door-stop device of claim 6 or claim 7, wherein, when said securing mechanism is secured to the door handle assembly, and the door is set within the doorframe, said extension arm has a first surface adapted to face said doorjamb, and wherein said first surface and said collar are attached whereby an inner facing of said collar and said first surface of said extension arm are disposed in substantially a same direction.

9. The door-stop device of claim 8, wherein grooves are disposed in said inner facing of said collar.

10. The door-stop device of claim 9, wherein each of said grooves is adapted to receive an insert, said insert protruding past said inner facing of the collar, and adapted to engage, when said securing mechanism is secured to the door handle assembly, an external surface of a rotating shaft of the door handle assembly.

11. The door-stop device of any of claims 8-10, wherein said first surface is a generally concave surface.

12. The door-stop device of any of claims 8-11, wherein said extension arm has a second surface adapted to face away from said doorjamb, and wherein said obstruction assembly is associated with, or substantially disposed between, said first surface and said second surface.

13. The door-stop device of any of claims 1-12, wherein said openings include at least one recessed opening.

14. The door-stop device of any of claims 1-13, wherein said openings are elongated openings dimensioned to provide mobility to said closure member as said closure member moves from one position to another position, and wherein said elongated openings may be substantially rectangular, oval, or rectangular with rounded ends.

15. The door-stop device of any of claims 1-14, wherein said arm includes, largely includes, substantially includes, or consists essentially of a resilient, flexible, substantially perfectly elastic material such as a polyoxymethylene thermoplastic polymer.

16. The door-stop device of any of claims 1-14, wherein said arm largely includes, substantially includes, or consists essentially of a polyoxymethylene thermoplastic polymer.

17. The door-stop device of any of claims 1-16, wherein said collar and said tabs include, largely include, substantially include, or consist essentially of a resilient, flexible, substantially perfectly elastic material such as a polyoxymethylene thermoplastic polymer.

18. The door-stop device of any of claims 1-16, wherein said collar and said tabs largely include, substantially include, or consist essentially of a polyoxymethylene thermoplastic polymer.

19. The door-stop device of any of claims 1-18, wherein said obstruction assembly includes at least one obstruction cushion, laterally protruding from both sides of said extension arm, and, adapted to at least partially absorb an impact between the door and said doorjamb.

20. The door-stop device of claim 19, wherein said at least one obstruction cushion is at least a pair of obstruction cushions, each of said pair protruding from one side of said sides of said arm.

21. The door-stop device of claim 19 or claim 20, wherein said extension arm includes a support frame disposed underneath said at least one obstruction cushion or between said pair of obstruction cushions, whereby said impact may be at least partially distributed over all of said support frame.

22. The door-stop device of claims 21, wherein said pair of obstruction cushions mechanically intercommunicates via said support frame, whereby said impact is transferred and distributed between said cushions.

23. The door-stop device of any of claims 19-22, wherein said cushion or cushions are made of a resilient, flexible material such as a thermoplastic rubber.

24. The door-stop device of any of claims 1-23, further comprising said doorjamb.

25. The door-stop device of any of claims 1-24, further comprising the door handle assembly.

26. The door-stop device of any of claims 1-25, further comprising the door.

27. The door-stop device of any of claims 1-26, wherein a tab of said tabs has a recess adapted to receive a threaded nut or element that is complementary with a surface of said closure member.

28. The door-stop device of claim 27, wherein said recess has a contour or a protruding element adapted to seat said threaded nut or element, whereby in an initial, untensioned, open position of said collar, with said closure member inserted through said openings, said threaded nut or element is disposed within 10°, within 8°, or within 5° of perpendicular, with respect to a longitudinal axis of said closure member.

29. The door-stop device of any of claims 1-28, wherein when a distance between a rotating shaft of the door handle assembly and a leading edge of the door is within a range of about 25 mm to about 65 mm, the door-stop device is adapted to universally function within an entire breadth of said range.

30. The door-stop device of any of claims 1-29, wherein a distance between a center of said collar and a distal edge of the door-stop device is at least 11 cm, at least 11.5 cm, at least 12 cm, or at least 12.5 cm.

31. The door-stop device of claim 30, wherein said distance between said center of said collar and said distal edge of the door-stop device is less than 20 cm, less than 18 cm, less than 16 cm, or less than 15 cm.

32. The door-stop device of any of claims 1-28, wherein a distance between a center of said collar and a distal edge of the door-stop device is at least 11 cm, at least 11.5 cm, at least 12 cm, or at least 12.5 cm, whereby, when a distance between a rotating shaft of the door handle assembly and a leading edge of the door is within a range of about 20 mm to about 65 mm, the door-stop device is adapted to universally function within an entire breadth of said range.

33. A door-stop device substantially as described herein, the door-stop device comprising any feature described, either individually or in combination with any feature, in any configuration.
